(19) United States
(12) Patent Application Publication
(10) Pub. No.: US 2010/0139300 A1
(43) Pub. Date: Jun. 10, 2010

(54) Refrigeration and control method thereof

(75) Inventors: Ha-jin Jeong, Gwangsan-gu (KR); Chang-nyeun Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/585,114

(22) Filed: Sep. 3, 2009

(30) Foreign Application Priority Data
Dec. 8, 2008 (KR) 10-2008-0123812

(51) Int. Cl. F25D 17/04; F25D 21/08; F25D 17/06; G05B 15/00

(52) U.S. Cl. 62/186; 62/276; 62/419; 700/275

(57) ABSTRACT

Disclosed is a refrigerator includes a storage room and having a cool air off mode in which supply of cool air to the storage room is cut off. Thus, a refrigerator having a cooling system in which a pair of evaporators are serially connected for a pair of storage rooms is provided according to the above embodiments. A refrigerator may also have a cooling system in which a plurality of evaporators is connected in parallel and refrigerant is selectively supplied to each evaporator by a refrigerant supply valve.

### CROSS-REFERENCE TO RELATED APPLICATIONS

This application claims priority from Korean Patent Application No. 10-2008-0123812, filed on Dec. 8, 2008 in the Korean Intellectual Property Office, the disclosure of which is incorporated herein by reference.

### BACKGROUND

1. Field

Apparatuses and methods consistent with the present invention relate to a refrigerator which has a cool air off mode in which a supply of cool air to a storage room is cut off, and a control method thereof.

2. Description of the Related Art

In general, a refrigerator has a storage room in which food is stored at low temperature.

The refrigerator further includes a cooling cycle which includes a compressor which compresses gaseous refrigerant at high temperature and high pressure; and a condenser which condenses the gaseous refrigerant into liquefied refrigerant; a capillary tube which decompresses the liquefied refrigerant; and an evaporator which performs heat exchange with the circumference using evaporating latent heat of the liquefied refrigerant passed through the capillary tube to generate cool air.

In such a refrigerator, sometimes a storage room is not used for power saving or due to other reasons during operation of the refrigerator.

### SUMMARY

Accordingly, it is an aspect of the present invention to provide a refrigerator in which cool air to the storage room may be selectively cut off.

Additional aspects and/or advantages will be set forth in part in the description which follows and, in part, will be apparent from the description, or may be learned by practice of the invention.

The foregoing and/or other aspects of the present invention may be achieved by providing a refrigerator including a storage room, and the refrigerator having a cool air off mode in which supply of cool air to the storage room is cut off.

The refrigerator may further include a fan which supplies the cool air to the storage room, and the fan may be operated to remove moisture remaining in the storage room in the cool air off mode.

The refrigerator may further include an evaporator which cools the storage room, and a defrost heater which defrosts the evaporator, and if the fan is operated, the defrost heater may be operated.

The refrigerator may further include a heater which is in contact with an outer wall of the storage room and supplies heat to the storage room, and the heater may be operated to remove moisture remaining in the storage room in the cool air off mode.

The foregoing and/or other aspects of the present invention may be achieved by providing a refrigerator, including: a body in which a storage room is formed; an evaporator which cools the storage room; and an input part which is provided to select a cool air off mode in which supply of cool air to the storage room is cut off.

The storage room and the evaporator may be provided in plurality, respectively, further including a refrigerant supply valve which selectively supplies refrigerant to each evaporator; and a controller which controls, if the cool air off mode is selected through the input part, the refrigerant supply valve so that the refrigerant is not supplied to the evaporator corresponding to the storage room in the cool air off mode.

The refrigerator may further include a fan which supplies cool air to the storage room, and the controller may operate, if the cool air off mode is selected through the input part, the fan to remove moisture remaining in the storage room in the cool air off mode.

The refrigerator may further include an evaporator which cools the storage room, and a defrost heater which defrosts the evaporator, and if the fan is operated, the controller may operate the defrost heater.

The refrigerator may further include a temperature sensor which measures temperature in the storage room, and the controller, if the cool air off mode is selected through the input part, and if temperature measured by the temperature sensor in the storage room in the cool air off mode is higher than outside temperature, may stop operation of the defrost heater and operate the fan.

The refrigerator may further include a heater which is in contact with an outer wall of the storage room and supplies heat to the storage room, and the controller, if the cool air off mode is selected through the input part, may operate the heater to remove moisture remaining in the storage room in the cool air off mode.

The refrigerator may further include a heater which is in contact with an outer wall of the storage room and supplies heat to the storage room, and the controller, if the cool air off mode is selected through the input part, may operate the heater to remove moisture remaining in the storage room in the cool air off mode.

The foregoing and/or other aspects of the present invention may be achieved by providing a control method of a refrigerator comprising a body in which a plurality of storage rooms are formed, a plurality of evaporators installed to respectively correspond to the plurality of storage rooms; and an input part through which a cool air off mode for the plurality of storage rooms is selectively inputted, the method including: inputting the cool air off mode for one of the plurality of the storage rooms through the input part; and cutting off supply of cool air to the storage room in the cool air off mode.

The refrigerator may further include a refrigerant supply valve which selectively supplies refrigerant to each evaporator, and the method may further include controlling the refrigerant supply valve so that the refrigerant is not supplied to the evaporator corresponding to the storage room in the cool air off mode.

The refrigerator may further include a fan which supplies cool air to the storage room, the method may further include operating the fan to remove moisture remaining in the storage room in the cool air off mode.

The refrigerator may further include a defrost heater which defrosts the evaporator, and the method may further include operating the defrost heater if the fan is operated.

The refrigerator may further include a temperature sensor which measures temperature in the storage room,

And the method further includes: measuring the temperature in the storage room in the cool air off mode by the temperature sensor; comparing the temperature in the storage room measured by the temperature sensor and outside temperature; and stopping operation of the heater corresponding to the storage room in the cool air off mode and operating the fan, if the temperature in the storage room measured by the temperature sensor is higher than the outside temperature.

The refrigerator may further include a heater which is in contact with an outer wall of the storage room and supplies heat to the storage room, and the method may further include operating the heater to remove moisture remaining in the storage room in the cool air off mode.

The refrigerator may further include a heater which is in contact with an outer wall of the storage room, and the method may further include operating the heater to remove moisture remaining in the storage room in the cool air off mode.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates a cooling cycle in a refrigerator according to an exemplary embodiment of the present invention;

FIG. 2 is a sectional view of a refrigerator having the cooling cycle in FIG. 1 according to an exemplary embodiment of the present invention;

FIG. 3 is a control block diagram of the refrigerator in FIG. 2;

FIG. 4 is a sectional view of a refrigerator having the cooling cycle in FIG. 1 according to another exemplary embodiment of the present invention; and

FIG. 5 is a control block diagram of the refrigerator in FIG. 4.

### DETAILED DESCRIPTION OF EMBODIMENTS

Reference will now be made in detail to the embodiments of the present invention, examples of which are illustrated in the accompanying drawings, wherein like reference numerals refer to like elements throughout. The exemplary embodiments are described below to explain the present invention by referring to the figures. Redundant description to different embodiments may be omitted as necessary.

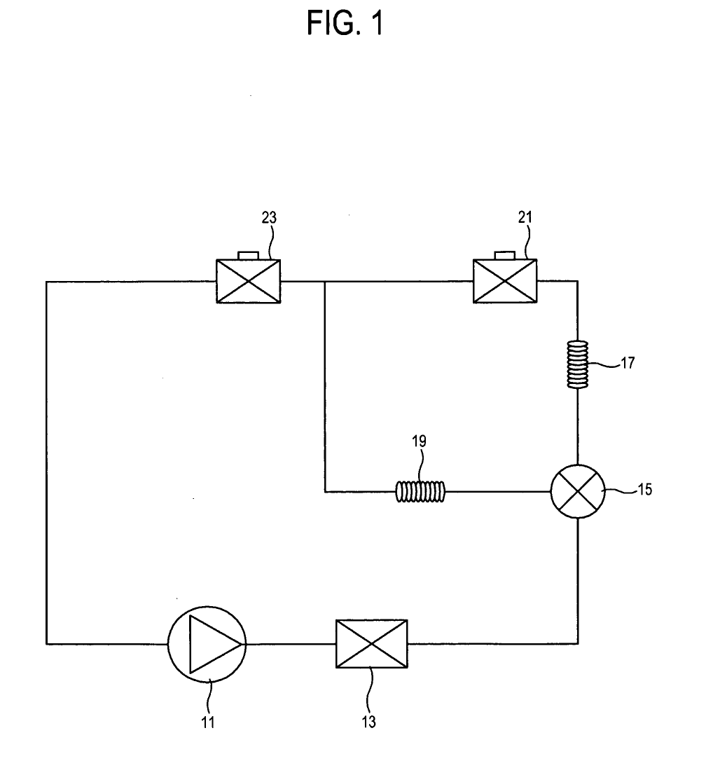

FIG. 1 illustrates a cooling cycle in a refrigerator according to an exemplary embodiment of the present invention. The cooling cycle includes a compressor which compresses gaseous refrigerant at high temperature and high pressure; a condenser 13 which condenses the gaseous refrigerant into liquefied refrigerant; a refrigerant supply valve 15 which selectively passes the liquefied refrigerant from the condenser 13 in two directions; a first and a second capillary tube 17 and 19 which decompress the liquefied refrigerant passed through the refrigerant supply valve 15; and a first and a second evaporator 21 and 23 which perform heat exchange with the circumference using evaporating latent heat of the liquefied refrigerant passed through the first and second capillary tubes 17 and 19. In this respect, the refrigerant supply valve 15 may be provided as a 3-directional valve.

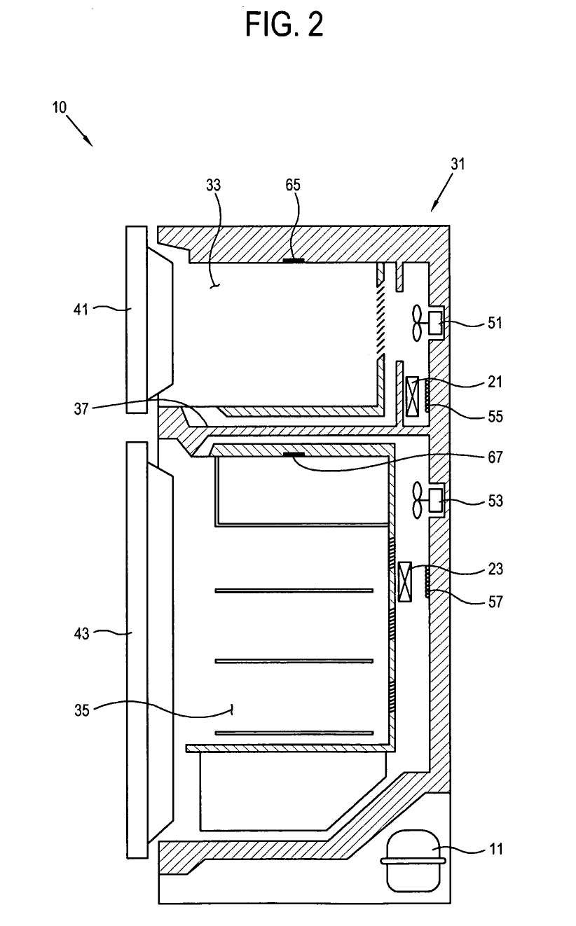

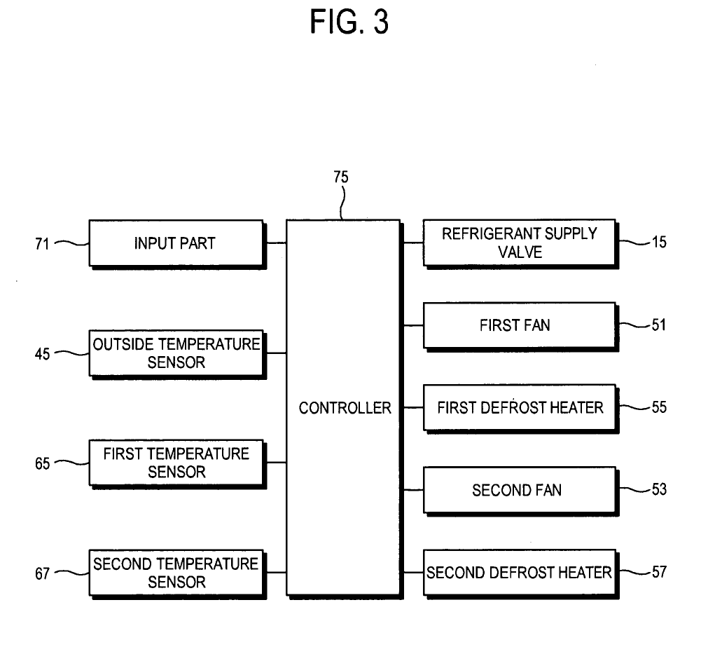

An indirect cooling refrigerator 10 having the above-described cooling cycle in FIG. 1 according to an exemplary embodiment of the present invention is illustrated in FIGS. 2 and 3.

The refrigerator 10 according to the present embodiment includes a body 31 which forms storage rooms 33 and 35, and doors 41 and 43 which open and close the storage rooms 33 and 35.

A first storage room 33 and a second storage room 35 each having a front opening are divided up and down by a compartment 37. The front openings of the storage rooms 33 and 35 are opened and closed by the doors 41 and 43. Inside the doors 41 and 43 are installed door guards (not shown) which contain bottles or the like. Outside of the body 31 is installed an outside temperature sensor 45 which measures outside temperature. The outside temperature sensor 45 transmits the measured outside temperature to a controller 75 (to be described later).

In a rear lower region of the body 31 is installed the compressor 11; and on a rear region of the body 31 are installed the first and second evaporators 21 and 23, which generate cool air by refrigerant compressed by the compressor 11. A first fan 51 and a second fan 53 are installed around the first and second evaporators 21 and 23 to supply the cool air generated from the first and second evaporators 21 and 23 to the first and second storage rooms 33 and 35, respectively. The first and second storage rooms 33 and 35 are cooled by the cool air. Further, the first and second fans 51 and 53 remove moisture remaining in the first and second storage rooms 33 and 35 in a cool air off mode.

In a region adjacent to the first and second evaporators 21 and 23 are installed defrost heaters 55 and 57. The defrost heaters 55 and 57 are operated in the cool air off mode in the storage rooms 33 and 35, and remove frost on an outer surface of the first and second evaporators 21 and 23. Further, the defrost heaters 55 and 57 generate heat to vaporize moisture remaining in the storage rooms 33 and 35 in the cool air off mode.

In the first storage room 33 is installed a first temperature sensor 65 which measures inside temperature of the first storage room 33; and in the second storage room 35 is installed a second temperature sensor 67 which measures inside temperature of the second storage room 35. The first temperature sensor 65 and the second temperature sensor 67 respectively transmit the measured inside temperatures of the first storage room 33 and the second storage room 35 to the controller 75.

The refrigerator 10 according to the present embodiment includes an input part 71 through which the cool air off mode is selected to cut off supply of cool air to the storage rooms 33 and 35. That is, the cool air is not supplied to the storage rooms 33 and 35 in the cool air off mode.

Further, the refrigerator 10 includes the controller 75 which controls operations of the refrigerant supply valve 15, the fans 51 and 53, and the defrost heaters 55 and 57.

The controller 75 controls the refrigerant supply valve 15 so that the refrigerant is not supplied to the evaporators 21 and 23 in the storage rooms 33 and 35 in the cool air off mode. Further, the controller 75 operates the fans 51 and 53 in the storage rooms 33 and 35 in the cool air off mode, and operates the defrost heaters 55 and 57 when the fans 51 and 53 of the storage rooms 33 and 35 are operated. Further, the controller 75 stops operation of the defrost heaters 55 and 57 and operates the fans 51 and 53, if temperatures measured by the temperature sensors 65 and 67 in the storage rooms 33 and 35 in the cool air off mode is higher than outside temperature.

Hereinafter, a process that the first storage room 33 of the refrigerator 10 with the above configuration according to the present embodiment goes into the cool air off mode and moisture remaining in the first storage room 33 is removed will be described.

Firstly, in order to cut off supply of cool air to the first storage room 33 which is not used and to save power consumption, a cool air off mode in the first storage room 33 is selected through the input part 71.

The controller 75 operates the refrigerant supply valve 15 to cut off supply of refrigerant from the condenser 13 to the first storage room 33, based on a signal of the input part 71.

The controller 75 then operates the first fan 51 in the first storage room 33 in the cool air off mode.

Then, the first defrost heater 55 is operated while the first fan 51 is operated.

Accordingly, the first fan 51 transfers heat generated from the first defrost heater 55 to the first storage room 33 and removes moisture remaining in the first storage room 33. Further, the heat generated from the first defrost heater 55 may remove frost on an outer surface of the first evaporator 21.

During the operation of the first fan 51, inside temperature of the first storage room 33 is measured by the first temperature sensor 65, and outside temperature thereof is measured by the outside temperature sensor 45.

The controller 75 compares the temperature in the first storage room 33 measured by the first temperature sensor 65 and the outside temperature measured by the outside temperature sensor 45.

If the temperature in the first storage room 33 is higher than the outside temperature, the controller 75 stops operation of the first defrost heater 55 and operates only the first fan 51.

The process that moisture remaining in the first storage room 33 in the cool air off mode is removed by the first fan 51 and the first defrost heater 55 is performed for a predetermined time.

As described above, the refrigerator 10 according to the present embodiment operates the first fan 51 and the first defrost heater 55 in the storage room 33 in the cool air off mode and transfers heat generated from the first defrost heater 55 to the first storage room 33, thereby removing moisture remaining in the first storage room 33 and reducing a bad smell and a germ growth. Further, due to operation of the first defrost heater 55, frost on the first evaporator 21 can be removed.

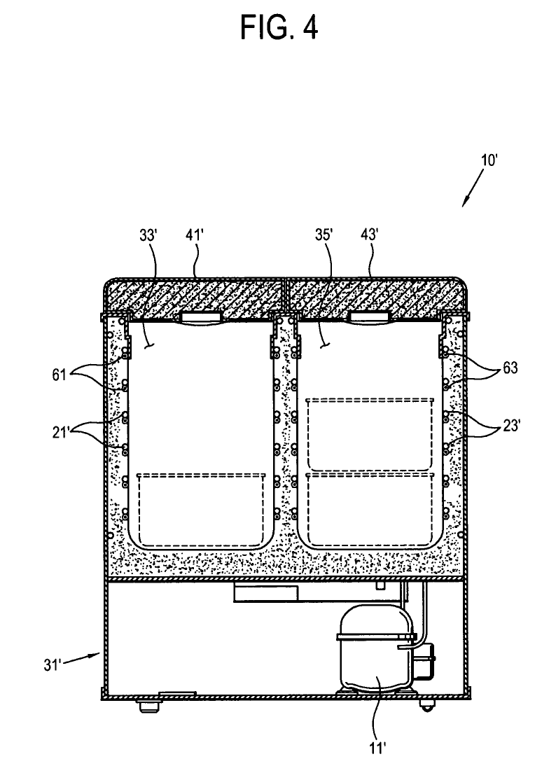

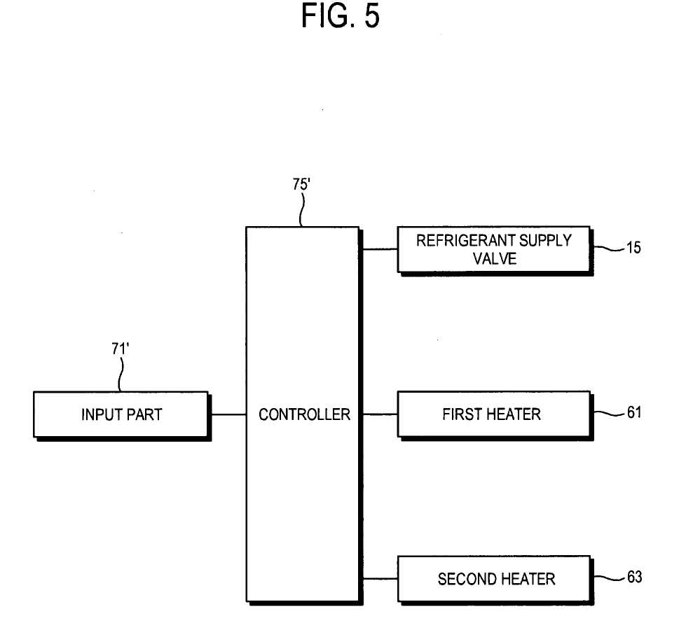

A direct cooling refrigerator 10′ having the above-described cooling cycle in FIG. 1 according to another exemplary embodiment of the present invention is illustrated in FIGS. 4 and 5.

The refrigerator 10′ includes a body 31′ which has an upward opening and forms storage rooms 33′ and 35′, and doors 41′ and 43′ which open and close the storage rooms 33′ and 35′.

In a lower region is installed a compressor 11′ which compresses refrigerant.

In the body 31′ are provided a first evaporator 21′ and a second evaporator 23′ which generate cool air for cooling the storage rooms 33′ and 35′ using the refrigerant compressed by the compressor 11′. The first and second evaporators 21′ and 23′ are installed to be in contact with an outer wall of the storage rooms 33′ and 35′ and directly cool the storage rooms 33′ and 35′.

In a portion of the body 31′, more specifically, on the outer wall of the storage rooms 33′ and 35′ are provided a first heater 61 and a second heater 63 which provide heat to the storage rooms 33′ and 35′. The first heater 61 and the second heater 63 directly heat the storage rooms 33′ and 35′ in the cool air off mode and remove moisture remaining in the storage rooms 33′ and 35′ in the cool air off mode. Further, the first heater 61 and the second heater 63 respectively heat the evaporators 21′ and 23′ to remove frost on an outer surface of the evaporators 21′ and 23′. Further, the first heater 61 and the second heater 63 are operated while cooling the storage rooms 33′ and 35′, for example, so as to ripen Kimchi stored in the storage rooms 33′ and 35′.

The refrigerator 10′ includes an input part 71′ which is provided to select a cool air off mode in which supply of cool air to the storage rooms 33 and 35 is cut off. That is, the cool air is not supplied to the storage rooms 33 and 35 in the cool air off mode.

Further, the refrigerator 10′ includes a controller 75′ which controls operations of the refrigerant supply valve 15 and the heaters 61 and 63.

The controller 75′ controls the refrigerant supply valve 15 so that refrigerant is not supplied to the evaporators 21′ and 23′ in the storage rooms 33′ and 35′ in the cool air off mode. Further, the controller 75′ controls the heaters 61 and 63 to be operated in the storage rooms 33′ and 35′, in the cool air off mode.

Hereinafter, a process that the first storage room 33′ of the refrigerator 10′ with the above-described configuration according to another embodiment goes into the cool air off mode and moisture remaining in the first storage room 33′ is removed will be described.

First, in order to cut off supply of cool air to the first storage room 33′ which is not used and to save power consumption, a cool air off mode in the first storage room 33′ is selected through the input part 71′.

The controller 75′ operates the refrigerant supply valve 15 to cut off supply of refrigerant from the condenser 13 to the first storage room 33′, based on a signal of the input part 71′.

The controller 75′ then operates the first heater 61 in the cool air off mode.

The first storage room 33′ is heated by the heat generated from the heater 61, and thus, moisture remaining in the storage room 33′ is removed. Further, the heat generated from the first heater 61 may remove frost on an outer surface of the first evaporator 21′.

The process in which moisture remaining in the first storage room 33 in the cool air off mode is removed by the first heater 61 is performed for a predetermined time.

Accordingly, the refrigerator 10′ according to another exemplary embodiment of the present invention operates the first heater 61 in the state that the first storage room 33′ is in the cool air off mode and transfers heat generated from the first heater 61 to the first storage room 33′, thereby removing moisture remaining in the first storage room 33′ and reducing a bad smell and a germ growth. Further, due to operation of the first heater 61, the first evaporator 21′ can be defrosted.

As described above, a refrigerator having a cooling system in which a pair of evaporators are serially connected for a pair of storage rooms is provided according to the above embodiments, but the embodiment of the present invention may be applied to a refrigerator having a cooling system in which a plurality of evaporators is connected in parallel and refrigerant is selectively supplied to each evaporator by a refrigerant supply valve.

Further, the embodiment of the present invention may be applied to a refrigerator which has one storage room.

Furthermore, the embodiment of the present invention may be applied to a direct/indirect hybrid cooling refrigerator, as well as a direct cooling refrigerator and an indirect cooling refrigerator.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A refrigerator comprising:
a storage room,
the refrigerator having a cool air off mode in which supply of cool air to the storage room is cut off.

2. The refrigerator according to claim 1, further comprising a fan which supplies the cool air to the storage room,
wherein the fan is operated to remove moisture remaining in the storage room in the cool air off mode.

3. The refrigerator according to claim 2, further comprising an evaporator which cools the storage room, and a defrost heater which defrosts the evaporator,
wherein if the fan is operated, the defrost heater is operated.

4. The refrigerator according to claim 1, further comprising a heater which is in contact with an outer wall of the storage room and supplies heat to the storage room,
wherein the heater is operated to remove moisture remaining in the storage room in the cool air off mode.

5. A refrigerator, comprising:
a body in which a storage room is formed;
an evaporator which cools the storage room; and
an input part which is provided to select a cool air off mode in which supply of cool air to the storage room is cut off.

6. The refrigerator according to claim 5,
further comprising a refrigerant supply valve which selectively supplies refrigerant to the evaporator; and
a controller which controls, if the cool air off mode is selected through the input part, the refrigerant supply valve so that the refrigerant is not supplied to the evaporator.

7. The refrigerator according to claim 6, further comprising a fan which supplies the cool air to the storage room,
wherein the controller operates, if the cool air off mode is selected through the input part, the fan to remove moisture remaining in the storage room in the cool air off mode.

8. The refrigerator according to claim 7, further comprising: a defrost heater which defrosts the evaporator,
wherein if the fan is operated, the controller operates the defrost heater.

9. The refrigerator according to claim 8, further comprising a temperature sensor which measures a temperature in the storage room,
wherein the controller, if the cool air off mode is selected through the input part, and if the temperature measured by the temperature sensor in the storage room in the cool air off mode is higher than the outside temperature, stops operation of the defrost heater and operates the fan.

10. The refrigerator according to claim 6, further comprising a heater which is in contact with an outer wall of the storage room and supplies heat to the storage room,
wherein the controller, if the cool air off mode is selected through the input part, operates the heater to remove moisture remaining in the storage room in the cool air off mode.

11. The refrigerator according to claim 7, further comprising a heater which is in contact with an outer wall of the storage room and supplies heat to the storage room,
wherein the controller, if the cool air off mode is selected through the input part, operates the heater to remove moisture remaining in the storage room in the cool air off mode.

12. A control method of a refrigerator, the refrigerator comprising:
a body in which a plurality of storage rooms are formed;
a plurality of evaporators installed to respectively correspond to the plurality of storage rooms; and
an input part through which a cool air off mode for the plurality of storage rooms is selectively inputted,
the method comprising:
inputting the cool air off mode for one of the plurality of the storage rooms through the input part; and
cutting off supply of cool air to the storage room in the cool air off mode.

13. The control method according to claim 12, wherein the refrigerator further comprises a refrigerant supply valve which selectively supplies refrigerant to each of the evaporator,
the method further comprising controlling the refrigerant supply valve so that the refrigerant is not supplied to the evaporator corresponding to the storage room in the cool air off mode.

14. The control method according to claim 13, wherein the refrigerator further comprises a fan which supplies cool air to the storage room,
the method further comprising operating the fan to remove moisture remaining in the storage room in the cool air off mode.

15. The control method according to claim 14, wherein the refrigerator further comprises a defrost heater which defrosts the evaporator,
the method further comprising operating the defrost heater if the fan is operated.

16. The control method according to claim 15, wherein the refrigerator further comprises a temperature sensor which measures temperature in the storage room,
the method further comprising:
measuring the temperature in the storage room in the cool air off mode by the temperature sensor;
comparing the temperature in the storage room measured by the temperature sensor and an outside temperature; and
stopping operation of the heater corresponding to the storage room in the cool air off mode and operating the fan, if the temperature in the storage room measured by the temperature sensor is higher than the outside temperature.

17. The control method according to claim 12, wherein the refrigerator further comprises a heater which is in contact with an outer wall of the storage room and supplies heat to the storage room,
the method further comprising operating the heater to remove moisture remaining in the storage room in the cool air off mode.

18. The control method according to claim 13, wherein the refrigerator further comprises a heater which is in contact with an outer wall of the storage room,
the method further comprising operating the heater to remove moisture remaining in the storage room in the cool air off mode.

19. The refrigerator according to claim 5, further comprising a plurality of the storage rooms and the evaporators.
